(19) United States
(12) Patent Application Publication
(10) Pub. No.: US 2006/0278764 A1
(43) Pub. Date: Dec. 14, 2006

(54) A method of commercial flight passenger boarding efficiently and safely

(76) Inventor: Yun Zhao, West Palm Beach, FL (US)

Correspondence Address: YUN ZHAO, 6 PINE RIDGE DR, WEST PALM BEACH, FL, 33404, US

(21) Appl. No.: 11/160,203

(22) Filed: Jun. 13, 2005

(51) Int. Cl. B64C 1/22

(52) U.S. Cl. 244/137.2

(57) ABSTRACT

For example: DC-9 Airplane have 120 seats, five for one row, from left to right have “A” “B” “C” “D” “E”, “A” and “E” are by windows, between “B” and “C” is aisle, from front to back, there are 24 rows. Current Air line will send passenger seat in row 18-24 as first group to board, then 11-17, then after 2-10. Use this way have tow disadvantage: few persons go to one row, it need few times for each person put luggage on gear and take seat; if not the one by windows take seat first, when some one need go in, they will leave seat let him in and take seat again. This is time consume. It will be twenty minutes for DC-9 boarding passenger once. Therefore use the method I claim now, by windows go first avoid swap seat and every row has passenger set luggage take seat at same time. Theoretically it will take teen minutes to board DC-9 once.

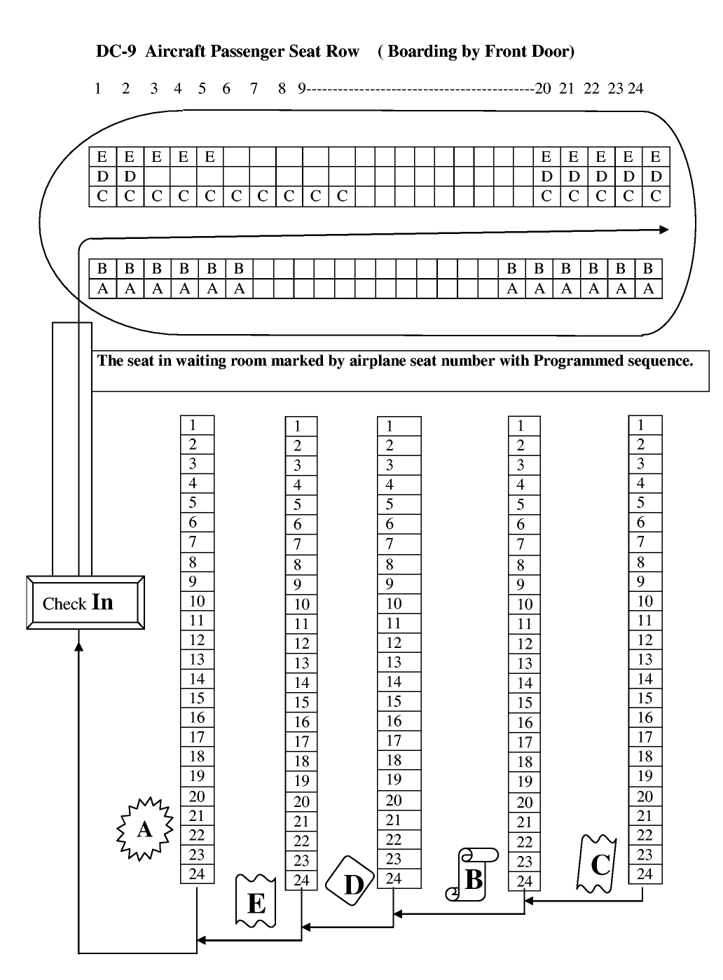

### DESCRIPTION

When Air line transport passenger, it would take time to board passenger to aircraft. Because most aircraft only has one door, and aisle access allow single person to go. So how make passenger line sequence by their seat number is crucial procedure to save time when boarding.

What is claimed is:

1. The sequence of passenger line to board has programmed by: First priority, “By windows” first, “next by windows” second, and by aisle last; Secondary priority, for each part of first priority, the seat far away from entrance first, close the entrance door last.

2. To Mark the seats in waiting room with flight aircraft seat number. Either by manual or by electronic device, Fellow the sequence as claim 1. Passenger should automatic sit the line like program already.
